(19) United States
(12) Patent Application Publication
(10) Pub. No.: US 2020/0161027 A1
(43) Pub. Date: May 21, 2020

(54) COMPOSITE STRANDED WIRE CONDUCTOR AND BENDING RESISTANT ELECTRIC WIRE

(71) Applicant: Yazaki Corporation, Tokyo (JP)

(72) Inventor: Yukihiro SAEKI, Susono-shi (JP)

(73) Assignee: Yazaki Corporation, Tokyo (JP)

(21) Appl. No.: 16/656,104

(22) Filed: Oct. 17, 2019

(30) Foreign Application Priority Data
Nov. 19, 2018 (JP) 2018-216158

(51) Int. Cl. H01B 13/02; H01B 7/00; H01B 7/04; H01B 13/00

(52) U.S. Cl. CPC H01B 13/02; H01B 13/0006; H01B 7/04; H01B 7/0009

(57) ABSTRACT

A composite stranded wire conductor includes a core bunched strand wire, first bunched strand wires mainly wound at a first main twist pitch around the core bunched strand wire, and second bunched strand wires wound at a second main twist pitch around first bunched strand wires. In the core bunched strand wire, metal wires are primary twisted in a first direction. In each of the first bunched strand wires, metal wires are primary twisted in a second direction opposite to the first direction. In each of the second bunched strand wires, metal wires are primary twisted in the first direction. A pitch ratio obtained by dividing the second main twist pitch by the first main twist pitch is 1.00 or more and 2.44 or less.

### CROSS-REFERENCE TO RELATED APPLICATIONS

This application is based on and claims priority under 35 USC 119 from Japanese Patent Application No. 2018-216158 filed on Nov. 19, 2018, the contents of which are incorporated herein by reference.

### TECHNICAL FIELD

The present disclosure relates to a composite stranded wire conductor and a bending resistant electric wire.

### BACKGROUND ART

JP2014137876A discloses a wire conductor for improving a durability to bending and a stability of a shape. The wire conductor has a two-layer structure including an inner layer formed by twisting metal wires, and an outer layer formed by twisting metal wires on the inner layer. The metal wires of the inner layer and the outer layer are twisted in the same direction, but the twist angles are different.

The inventor is researching a composite stranded wire conductor formed by a main twist in which a plurality of bunched strand wires are twisted, the bunched strand wires being formed by a primary twist in which a plurality of conductive wires are twisted, and a bending resistant electric wire including a composite stranded wire conductor.

JP2014137876A discloses that “the contact between wires of adjacent layers is reduced, and wires of an outer layer are prevented from entering into gaps between adjacent wires in the inner layer, so that the durability to bending and the stability of the shape for the stranded wire conductor can be improved”. However, according to the structure of JP 2014-137876 A, since the twist direction is the same, the wires may enter between the wires of the adjacent layers, it would be difficult to improve the stability of the shape.

Therefore, according to the structure of JP2014137876A, the shape stability cannot be improved while ensuring the bending resistance.

### SUMMARY OF INVENTION

According to exemplary embodiments, a composite stranded wire conductor and a bending resistant electric wire capable of improving a shape stability while ensuring a bending resistance is provided.

In accordance with exemplary embodiments, a composite stranded wire conductor includes, a core bunched strand wire, a first layer composite stranded wire and a second layer composite stranded wire. In the core bunched strand wire, a plurality of conductive metal wires are primarily twisted. The first layer composite stranded wire includes a plurality of first bunched strand wires. A plurality of conductive metal wires are primarily twisted in each of the plurality of first bunched strand wires. The plurality of first bunched strand wires are mainly twisted around the core bunched strand wire. A second layer composite stranded wire including a plurality of second bunched strand wires. A plurality of conductive metal wires are primarily twisted in each of the plurality of second bunched strand wires. The plurality of second bunched strand wires are mainly twisted around the first layer composite stranded wire. The plurality of conductive metal wires are primarily twisted in a first direction in the core bunched strand. The plurality of conductive metal wires are primarily twisted in a second direction opposite to the first direction in each of the plurality of first bunched strand wires. The plurality of first bunched strand wires are mainly twisted in the second direction at a first main twist pitch in the first layer composite stranded wire. The plurality of conductive metal wires are primarily twisted in the first direction in each of the plurality of second bunched strand wires. The plurality of second bunched strand wires are mainly twisted in the first direction at a second main twist pitch in the second layer composite stranded wire. A primary twist pitch of the core bunched strand wire, a primary twist pitch of the each of the first bunched strand wires, and a primary twist pitch of the each of the second bunched strand wires are substantially the same with each other. A pitch ratio obtained by dividing the second main twist pitch by the first main twist pitch is 1.00 or more and 2.44 or less.

According to exemplary embodiments, the primary twist and main twist of the first layer composite stranded wire are performed in a second direction, and the primary twist and main twist of the second layer composite stranded wire are performed in a first direction, so that the directions of the primary twist and main twist are the same in the first layer composite stranded wire, and the directions of the primary twist and main twist are the same in the first layer composite stranded wire. Therefore, wires become difficult to enter between wires in the same layer, the bending resistance can be ensured.

Further, the primary twist of the core bunched strand wire is performed in the first direction, and the primary twist and the main twist of the second layer composite stranded wire are also performed in the first direction, while the primary twist and the main twist of the first layer composite stranded wire are performed in the second direction. Therefore, the metal wires configuring the core bunched strand wire and the metal wires configuring the bunched strand wires of the second layer composite stranded wire do not easily enter between the metal wires of the first layer composite stranded wire. As a result, the shape of the conductor after stranding is unlikely to be flat and the shape stability can be improved.

In addition, the primary twist pitch of the core bunched strand wire, the first layer composite stranded wire, and the second layer composite stranded wire is substantially the same. Therefore, the primary twist collapse at the time of bending can be made equal in each layer, and the flatness of the electric wire can be prevented. Further, in the present specification, the sentence “the primary twist pitch of the core bunched strand wire, the first layer composite stranded wire, and the second layer composite stranded wire is substantially the same” means that differences between the primary twist pitch of the core bunched strand wire, the primary twist pitch of the first bunched strand wire and the primary twist pitch of the second bunched strand wire are set within 11%.

According to exemplary embodiments, the pitch ratio of the main twist pitch for the second layer composite stranded wire divided by the main twist pitch for the first layer composite stranded wire is 1.00 or more and 2.44 or less. Therefore, the pitch ratio is not less than one and thereby can be manufactured, and the frequency of occurrence of twist float due to the pitch ratio exceeding 2.44 can be suppressed, and the possibility of a decrease in the bending resistance due to the twist float can be reduced.

Therefore, the shape stability can be improved while ensuring the bending resistance.

According to exemplary embodiments, it is possible to provide a composite stranded wire conductor and a bending resistant electric wire capable of improving the shape stability while securing the bending resistance.

### BRIEF DESCRIPTION OF DRAWINGS

FIG. 1 is a perspective view showing an example of a bending resistant electric wire including a composite stranded wire conductor according to a first embodiment.

FIG. 2A is a cross-sectional view schematically showing a first example of the composite stranded wire conductor shown in FIG. 1.

FIG. 2B is a cross-sectional view schematically showing a second example of the composite stranded wire conductor shown in FIG. 1.

FIG. 3 is a table showing twist directions of the composite stranded wire conductor according to the present embodiment.

FIG. 4A shows a cross section of a bending resistant electric wire in which all the twist directions are the same.

FIG. 4B shows a cross section of a bending resistant electric wire according to the first example shown in FIGS. 2A and 3.

FIG. 5 is a table showing details of composite stranded wire conductors according to examples of the present embodiment and comparative examples.

FIG. 6 is a table showing the number of bending and the flatness ratio of bending resistant electric wires using the composite stranded wire conductors according to Examples 1 to 3 and Comparative Example 1.

FIG. 7 is a graph showing the number of bending and the flatness ratio of the bending resistant electric wires using the composite stranded wire conductors according to Examples 1 to 3 and Comparative Example 1.

FIG. 8 is a table showing the number of bending and the flatness ratio of bending resistant electric wires using the composite stranded wire conductors according to Example 2 and Comparative Examples 2 and 3.

FIG. 9 is a graph showing the number of bending and the flatness ratio of the bending resistant electric wires using the composite stranded wire conductors according to Examples 2 and Comparative Examples 2 and 3.

FIG. 10 is a table showing the bending resistant electric wires according to Examples 2, 4 and 5, and Comparative Examples 2 and 4.

FIG. 11 is a table showing the number of bending and the flatness ratio of bending resistant electric wires using the composite stranded wire conductors according to Examples 2, 4 and 5, and Comparative Examples 2 and 4.

FIG. 12 is a graph showing the number of bending and the flatness ratio of the bending resistant electric wires using the composite stranded wire conductors according to Examples 2, 4 and 5, and Comparative Examples 2 and 4.

### DESCRIPTION OF EMBODIMENTS

Hereinafter, the present disclosure will be described based on embodiments. The present invention is not limited to the embodiments described below, and can be appropriately modified without departing from the scope of the present invention. In the embodiments described below, some configurations are not shown or described, but it goes without saying that a known or well-known technique is appropriately applied to details of an omitted technique within a range in which no contradiction occurs to contents described below.

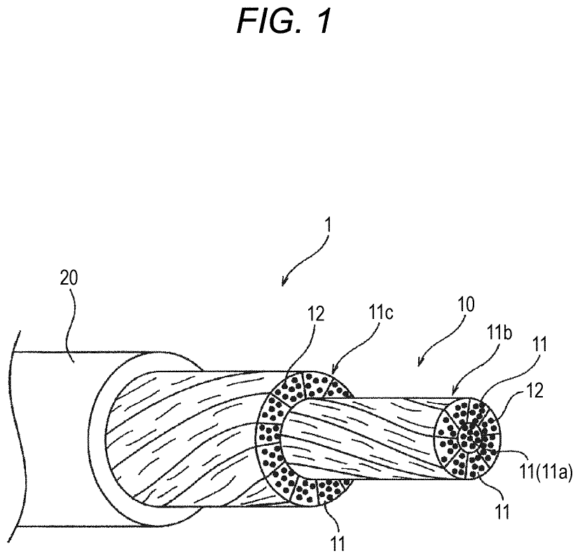

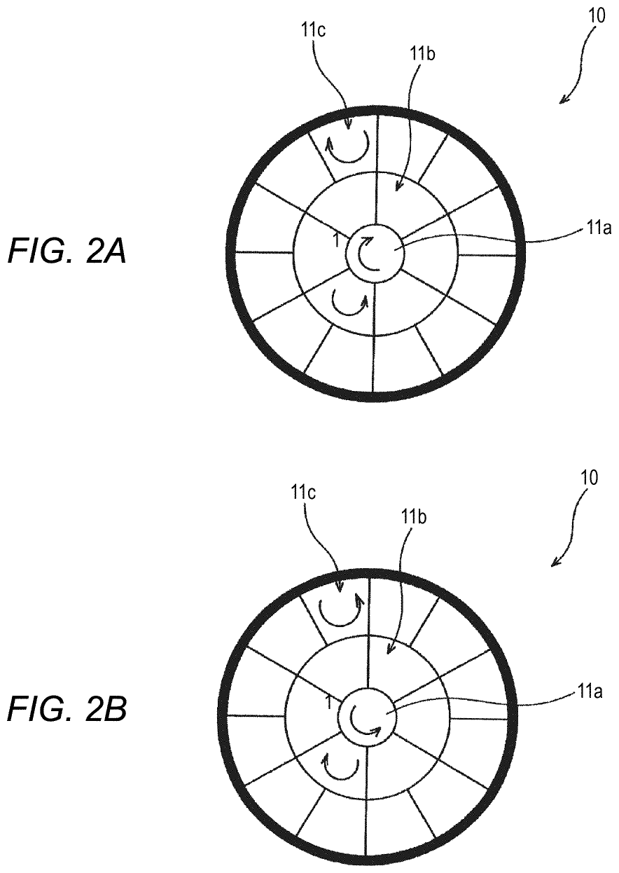

FIG. 1 is a perspective view showing an example of a bending resistant electric wire including a composite stranded wire conductor according to a first embodiment. FIGS. 2A and 2B are cross-sectional views schematically showing the composite stranded wire conductor shown in FIG. 1, in which FIG. 2A shows a first example, and FIG. 2B shows a second example. As shown in FIG. 1, a bending resistant electric wire 1 is configured by a composite stranded wire conductor 10 and an insulator 20 provided on the composite stranded wire conductor 10.

The composite stranded wire conductor 10 includes a plurality of bunched strand wires 11. Each of the plurality of bunched strand wires 11 are formed by primarily twisting a plurality of conductive metal wires 12. The bunched strand wire 11 in the present embodiment is configured by stranding, for example, one handled and twenty six (126) metal wires 12 made of pure copper. The diameter of the metal wire 12 is, for example, 0.08 mm or less. The twist performed at the time of stranding the metal wires 12 to form the bunched strand wires 11 is called primary twist.

The composite stranded wire conductor 10 in the present embodiment has a three-layer structure of a core bunched strand wire 11a, a first layer composite stranded wire 11b, and a second layer composite stranded wire 11c. The core bunched strand wire 11a is a bunched strand wire 11 located closest to the center of the cross section. The first layer composite stranded wire 11b is formed by twisting a plurality of bunched strand wires 11 provided to overlap the periphery of the core bunched strand wire 11a. The second layer composite stranded wire 11c is formed by twisting a plurality of bunched strand wires 11 provided to overlap the periphery of the first layer composite stranded wire 11b. Here, the twist performed at the time of forming the first layer composite stranded wire 11b or the second layer composite stranded wire 11c from a plurality of bunched strand wires 11 is called main twist.

In the present embodiment, the first layer composite stranded wire 11b is formed by mainly twisting six bunched strand wires 11, and the second layer composite stranded wire 11c is formed by mainly twisting twelve bunched strand wires 11, for example. However, the number of the bunched strand wires 11 is not limited thereto, and the first layer composite stranded wire 11b may be formed by mainly twisting eight bunched strand wires 11 as shown in FIG. 1, for example. Further, the second layer composite stranded wire 11c may also be formed by eighteen bunched strand wires 11, but not limited to 12.

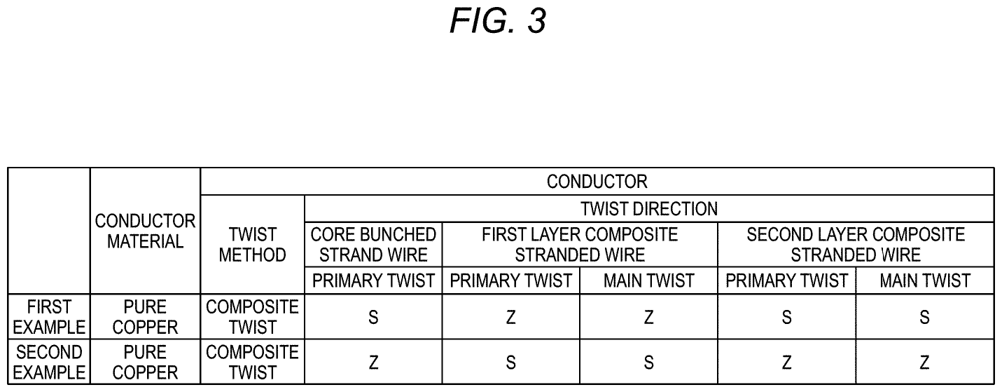

In addition, the composite stranded wire conductor 10 in the present embodiment has the following twist configuration. FIG. 3 is a table showing twist directions of the composite stranded wire conductor 10 according to the present embodiment.

As shown in FIG. 3, in a first example (example in FIG. 2A), the core bunched strand wire 11a is S-twisted. The second layer composite stranded wire 11c is also S-twisted in both the primary twist and the main twist. On the other hand, the first layer composite stranded wire 11b is Z-twisted in both the primary twist and the main twist. That is, among the three layers, the primary twist and the main twist of the first layer and the third layer are in the same direction (first direction), and the primary twist and the main twist of the second layer is in a direction (second direction) opposite to the direction.

Further, as shown in the second example (example in FIG. 2B), the core bunched strand wire 11a and the second layer composite stranded wire 11c are Z-twisted by both the primary twist and the main twist, and the first layer composite stranded wire 11b is S-twisted by both the primary twist and the main twist.

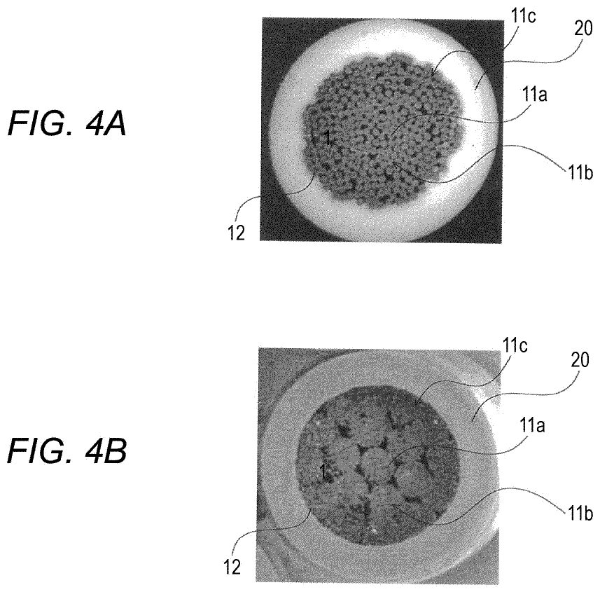

By adopting such a configuration, the bending resistant electric wire 1 according to the present embodiment is configured such that the composite stranded wire conductor 10 is unlikely to become elliptical. FIGS. 4A and 4B are views showing cross sections of bending resistant electric wires, in which FIG. 4A shows a cross section of a bending resistant electric wire when all the twist directions are the same, and FIG. 4B shows a cross section of the bending resistant electric wire 1 according to the first example shown in FIGS. 2A and 3.

As shown in FIG. 4A, in a case where the twist directions of all primary twists and main twists of the core bunched strand wire 11a, the first layer composite stranded wire 11b, and the second layer composite stranded wire 11c are the same direction, the metal wires 12 may easily enter between other metal wires 12, and the shape of the conductor after stranding is flat.

In contrast, in the present embodiment, the metal wires 12 configuring the core bunched strand wire 11a and the metal wires 12 configuring the bunched strand wires 11 of the second layer composite stranded wire 11c do not easily enter between the metal wires 12 of the first layer composite stranded wire 11b. As a result, as shown in FIG. 4B, the shape of the conductor after stranding is unlikely to be flat and can be close to a perfect circle when viewed in cross section.

Further, in the present embodiment, the directions of the primary twist and main twist for the first layer composite stranded wire 11b are the same, and directions of the primary twist and main twist for the second layer composite stranded wire 11c are the same. Accordingly, wires 12 in a bunched strand wire are difficult to enter between wires 12 of adjacent bunched strand wire in the same layer. Therefore, the bending resistance can be improved.

In addition, the primary twist pitch of the core bunched strand wire 11a, the first layer composite stranded wire 11b, and the second layer composite stranded wire 11c is substantially the same (error within 11%). Therefore, the primary twist collapse at the time of bending can be made equal in each layer, and the flatness of the electric wire 1 can be prevented.

Further, in the bending resistant electric wire 1 according to the present embodiment, a pitch ratio of the main twist pitch for the second layer composite stranded wire 11c divided by the main twist pitch for the first layer composite stranded wire 11b is 1.00 or more and 2.44 or less.

It is because the manufacture becomes impossible when the pitch ratio is less than 1. Further, when the pitch ratio exceeds 2.44, twist float is likely to occur, and a decrease in bending resistance due to the twist float is likely to occur.

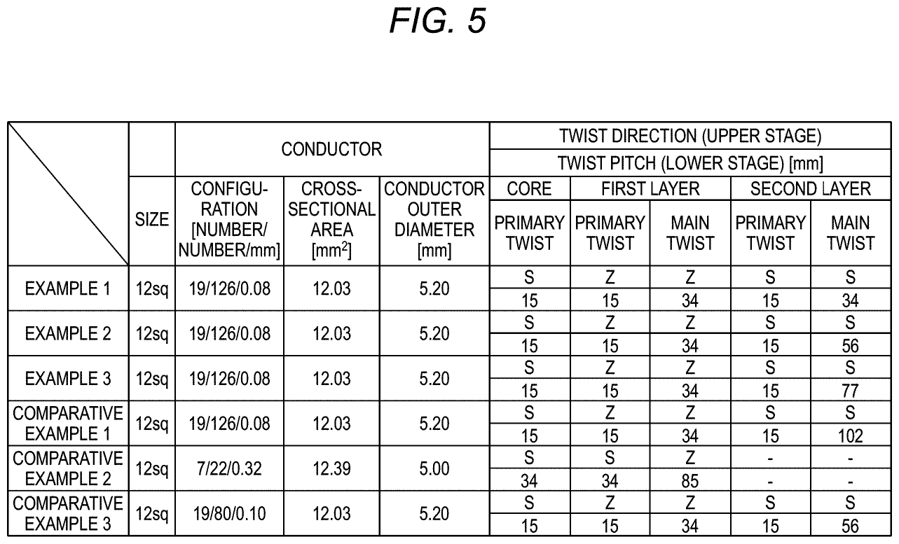

Next, Examples and Comparative Examples will be described. FIG. 5 is a table showing details of composite stranded wire conductors according to examples of the present embodiment and comparative examples.

As shown in FIG. 5, the composite stranded wire conductors according to Examples 1 to 3 and Comparative Example 1 all have a conductor size of 12 sq. Pure copper was used for the metal wires.

In Examples 1 to 3 and Comparative Example 1, 126 metal wires having a diameter of 0.08 mm were primarily twisted to form a bunched strand wire, and 19 such bunched strand wires were used to form a composite stranded wire conductor. A core stranded wire was formed by one bunched strand wire, a first layer bunched strand wire was formed by six bunched strand wires, and a second layer composite stranded wire was formed by twelve bunched strand wires. The cross-sectional area of such a conductor portion was 12.03 mm2, and a conductor outer diameter was 5.20 mm.

In Examples 1 to 3 and Comparative Example 1, a direction for the primary twist of the core stranded wire was direction S, a direction for the primary twist and the main twist of the first layer bunched strand wire was direction Z, and a direction for the primary twist and the main twist of the second layer bunched strand wire was direction S. A primary twist pitch for the core stranded wire, the first layer bunched strand wire, and the second layer bunched strand wire were all 15 mm. Further, the main twist pitch for the first layer bunched strand wire was 34 mm. The main twist pitch for the second layer composite stranded wire in Example 1 was 34 mm, in Example 2 was 56 mm, in Example 3 was 77 mm, and in Comparative Example 1 was 102 mm. Therefore, a pitch ratio in Example 1 was “1.00”, in Example 2 was “1.65”, in Example 3 was “2.26”, and in Comparative Example 1 was “3.00”.

A predetermined bending test was performed on a bending resistant electric wire in which the composite stranded wire conductor according to Examples 1 to 3 and Comparative Example 1 was respectively covered with an insulator A. In addition, as the insulator A, a mixture of an elastomer (product name: Esprene EPDM 6101 manufactured by Sumitomo Chemical) and a flame retardant (brominated flame retardant+antimony trioxide) with respect to a resin (product name: ENGAGE 8452 manufactured by DOW Chemical) was used. A ratio of resin to elastomer is 8:2 to 6:4. Further, a blending amount of the flame retardant is 40 phr.

In the bending test, a cylindrical mandrel bending tester was used, from a state in which each bending resistant electric wire was straightened, bending was repeatedly performed with a bending radius of 30 mm in an angle range of 0° to 120° at normal temperature, and the number of bending reciprocations (number of bending) when the wire was broken (that is, when the resistance of the conductor increased by 10% than before bending) was measured. In the bending test, no load was applied and a bending speed was once per second. The environmental temperature at the time of bending was set to minus 40 degrees.

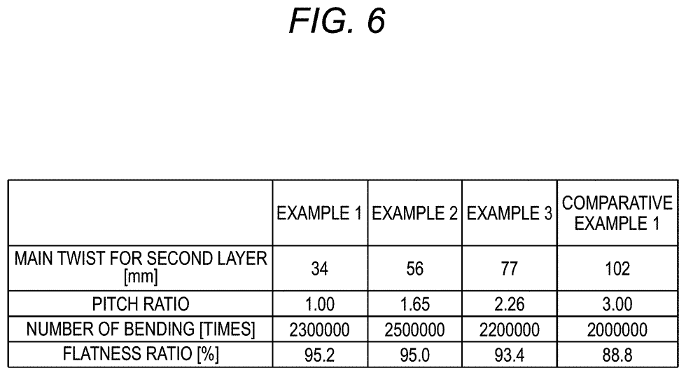

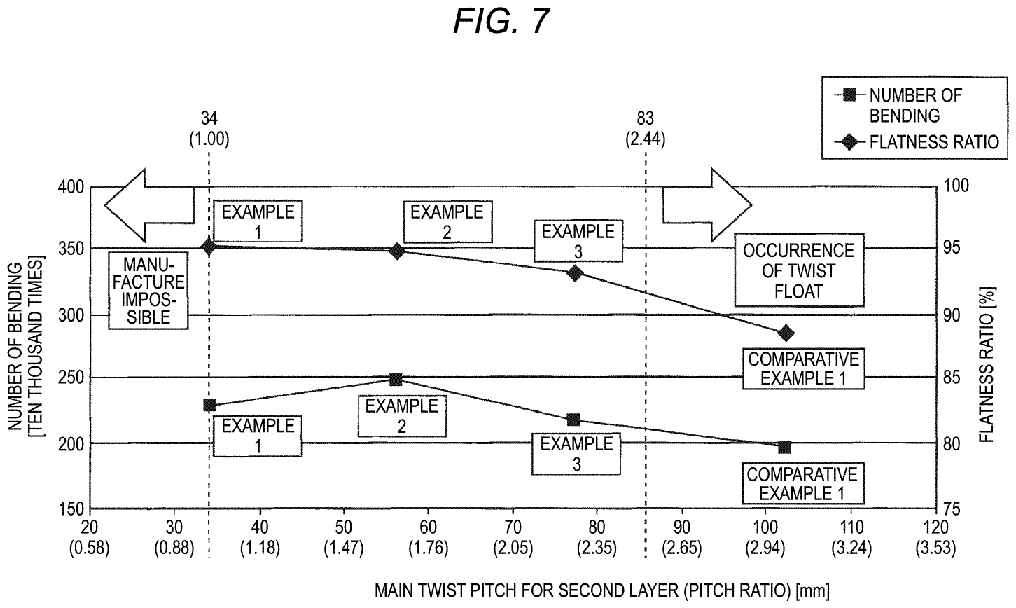

FIG. 6 is a table showing the number of bending and the flatness ratio of bending resistant electric wires using the composite stranded wire conductors according to Examples 1 to 3 and Comparative Example 1. FIG. 7 is a graph showing the number of bending and the flatness ratio of the bending resistant electric wires using the composite stranded wire conductors according to Examples 1 to 3 and Comparative Example 1. The minimum value X and the maximum value Y of the external dimension of the composite stranded wire conductor were measured when viewed in the cross section, and the flatness ratio was calculated based on the formula X/Y×100.

As shown in FIGS. 6 and 7, for the bending resistant electric wire using the composite stranded wire conductor according to Example 1, the number of bending was 2.3 million times and the flatness ratio was 95.2%. For the bending resistant electric wire using the composite stranded wire conductor according to Example 2, the number of bending was 2.5 million times and the flatness ratio was 95.0%. For the bending resistant electric wire using the composite stranded wire conductor according to Example 3, the number of bending was 2.2 million times and the flatness ratio was 93.4%. For the bending resistant electric wire using the composite stranded wire conductor according to Comparative Example 1, the number of bending was 2.0 million times and the flatness ratio was 88.8%.

Here, in the present embodiment, assuming that a target value in the bending test was 2.15 million times and a target value of the flatness ratio was 92%, as shown in FIG. 6, the target value was achieved for Examples 1 to 3 in which the pitch ratios were “1.00”, “1.65”, and “2.26”, while the target value was not achieved for Comparative Example 1 in which the pitch ratio was “3.00”. Although illustration or the like by Example is omitted, it was found that the target value can be achieved if the pitch ratio is “2.44” or less. This is because when the pitch ratio is “2.44” or less, twist float is unlikely to occur, and a decrease in the bending resistance due to the twist float is unlikely to occur. As described above, the pitch ratio cannot be less than “1.00” due to manufacturing. Therefore, it was found that a target value can be achieved if the pitch ratio is “1.00” or more and “2.44” or less.

Further, the composite stranded wire conductors according to Example 2 and Comparative Examples 2 and 3 shown in FIG. 5 will be described. The Example 2 is as described above. The composite stranded wire conductor according to Comparative Example 2 has a conductor size of 12 sq. Pure copper was used for the metal wires.

In Comparative Example 2, 22 metal wires having a diameter of 0.32 mm were primarily twisted to form a bunched strand wire, and 7 such bunched strand wires were used to form a composite stranded wire conductor. A core stranded wire was formed by one bunched strand wire, and a first layer bunched strand wire was formed by six bunched strand wires. In Comparative Example 2, the second layer composite stranded wire is not included. The cross-sectional area of such a conductor portion was 12.39 mm², and a conductor outer diameter was 5.00 mm.

In Comparative Example 2, a direction for the primary twist of the core stranded wire was direction S, and a direction for the main twist of the first layer bunched strand wire was direction Z. A primary twist pitch for the core stranded wire and the first layer bunched strand wire were both 34 mm. Further, the main twist pitch for the first layer bunched strand wire was 85 mm. The Comparative Example 2 conforms to JASO D624, and covers an insulator B to form a bending resistant electric wire. In addition, as the insulator B, a mixture of an elastomer and a flame retardant (magnesium hydroxide) with respect to a resin (product name: LOTRYL24MA005 manufactured by ARKEMA) was used. A blending amount of the flame retardant is 40 to 80 phr.

In Comparative Example 3, 80 metal wires having a diameter of 0.10 mm were primarily twisted to form a bunched strand wire. Except for this point, Comparative Example 3 is the same as Example 2. The Comparative Example 3 covers the insulator A to form a bending resistant electric wire.

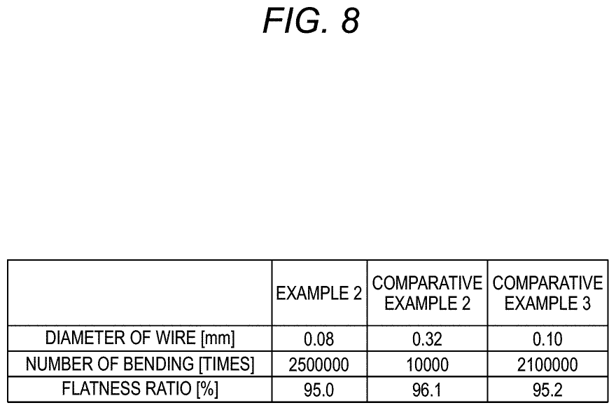

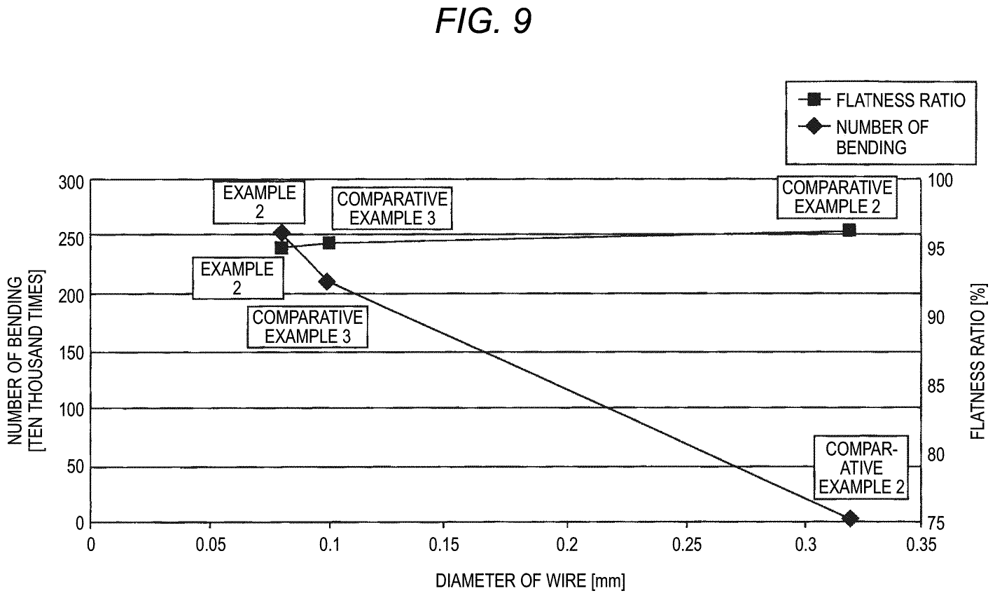

FIG. 8 is a table showing the number of bending and the flatness ratio of bending resistant electric wires using the composite stranded wire conductors according to Example 2 and Comparative Examples 2 and 3. FIG. 9 is a graph showing the number of bending and the flatness ratio of the bending resistant electric wires using the composite stranded wire conductors according to Examples 2 and Comparative Examples 2 and 3. In the table shown in FIG. 8 and the graph shown in FIG. 9, the same bending test as described above was performed, and the flatness ratio was also calculated using the same calculation formula as described above.

As shown in FIGS. 8 and 9, for the bending resistant electric wire using the composite stranded wire conductor according to Example 2, the number of bending was 2.5 million times and the flatness ratio was 95.0%. For the bending resistant electric wire using the composite stranded wire conductor according to Comparative Example 2, the number of bending was 10,000 times and the flatness ratio was 96.1%. For the bending resistant electric wire using the composite stranded wire conductor according to Comparative Example 3, the number of bending was 2.1 million times and the flatness ratio was 95.2%.

Therefore, it was found that only Example 2 in which the diameter of the metal wire is 0.08 mm can achieve a target value (2.15 million or more times in the number of bending and 92% or more in flatness ratio). Although illustration or the like is omitted, it was found that when the diameter is smaller than 0.08 mm, the number of bending increases. Therefore, it was found that the diameter of the metal wire is preferably 0.08 mm or less.

Even when the diameter of the metal wire exceeds 0.08 mm (for example, the case in Comparative Example 3), there are cases where the target value can be achieved by adjusting the pitch or the pitch ratio. For example, the pitch ratio of Comparative Example 3 is set to a small value, so that the number of bending can be increased to achieve the target value. Therefore, the diameter of the metal wire is not limited to 0.08 mm or less.

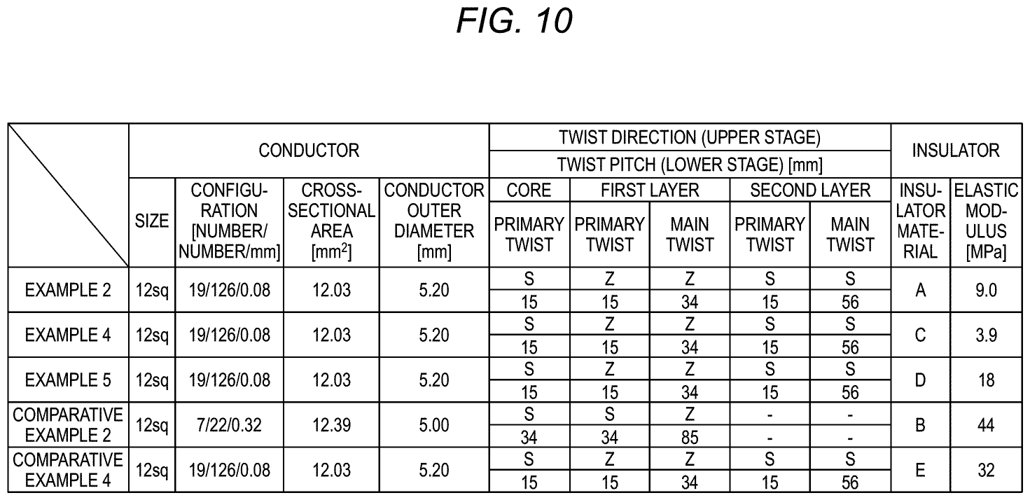

FIG. 10 is a table showing the bending resistant electric wires according to Examples 2, 4 and 5, and Comparative Examples 2 and 4. The Examples 4 and 5 differ from the Example 2 only in the type of insulator. In Example 2, the composite stranded wire conductor is covered with the insulator A. In Example 4, the same composite stranded wire conductor as that in Example 2 is covered with the insulator C. and in Example 5, the same composite stranded wire conductor as that in Example 2 is covered with the insulator D.

As the insulator C, a mixture of an elastomer (product name: Esprene EPDM 6101 manufactured by Sumitomo Chemical) and a flame retardant (brominated flame retardant+antimony trioxide) with respect to a resin (product name: ENGAGE 8452 manufactured by Dow Chemical) was used. A blending amount of the flame retardant is 40 phr.

As the insulator D, a mixture of a flame retardant (brominated flame retardant+antimony trioxide) with respect to a resin (product name: ENGAGE 8452 manufactured by DOW Chemical) was used. A blending amount of the flame retardant is 40 phr.

The Comparative Example 2 is the same as described above. In Comparative Example 4, the same composite stranded wire conductor as that in Example 2 was covered with an insulator E. As the insulator E, a mixture of a flame retardant (brominated flame retardant+antimony trioxide) with respect to a resin (product name: Rexpearl A4250 and Rexpearl A1150 manufactured by Nippon Polyethylene blended at 8:2) was used. A blending amount of the flame retardant is 35 phr.

For the bending resistant electric wires described above, the elastic modulus of each insulator is 9.0 MPa in Example 2 (insulator A), 3.9 MPa in Example 4 (insulator C), 18 MPa in Example 5 (insulator D), 44 MPa in Comparative Example 1 (insulator B), and 32 MPa in Comparative Example 5 (insulator E).

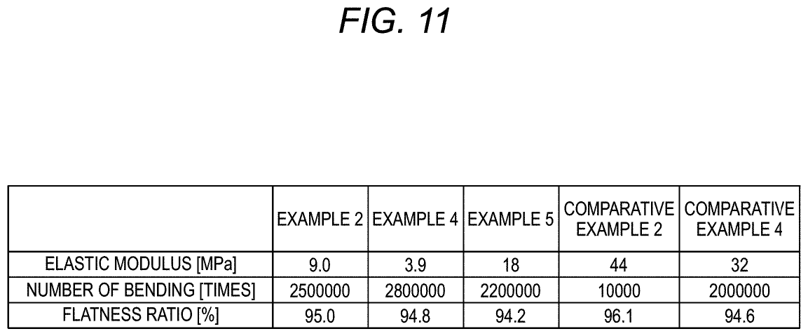

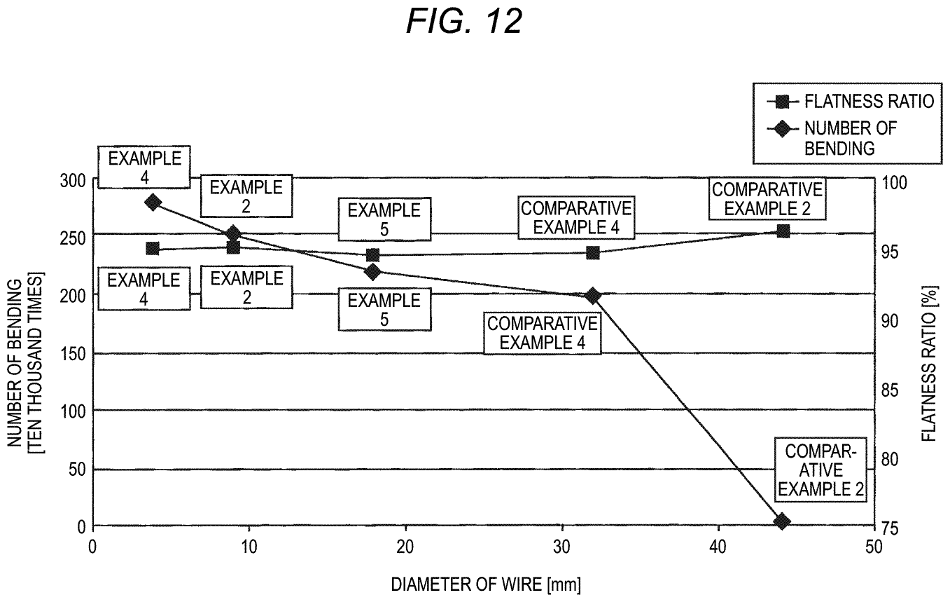

FIG. 11 is a table showing the number of bending and the flatness ratio of bending resistant electric wires using the composite stranded wire conductors according to Examples 2, 4 and 5, and Comparative Examples 2 and 4. FIG. 12 is a graph showing the number of bending and the flatness ratio of the bending resistant electric wires using the composite stranded wire conductors according to Examples 2, 4 and 5, and Comparative Examples 2 and 4. In the table shown in FIG. 11 and the graph shown in FIG. 12, the same bending test as described above was performed, and the flatness ratio was also calculated using the same calculation formula as described above.

As shown in FIGS. 11 and 12, for the bending resistant electric wire according to Example 4, the number of bending was 2.8 million times and the flatness ratio was 94.8%. For the bending resistant electric wire according to Example 2, the number of bending was 2.5 million times and the flatness ratio was 95.0%. For the bending resistant electric wire according to Example 5, the number of bending was 2.2 million times and the flatness ratio was 94.2%. For the bending resistant electric wire according to Comparative Example 1, the number of bending was 10,000 times and the flatness ratio was 96.1%. For the bending resistant electric wire according to Comparative Example 4, the number of bending was 2.0 million times and the flatness ratio was 94.6%.

Therefore, it was found that only the bending resistant electric wire covered with the insulator whose elastic modulus is 18 MPa or less can achieve the target value (2.15 million or more times in the number of bending and 92% or more in flatness ratio). Although the illustration is omitted, even when the elastic modulus exceeds 18 MPa (for example, the case in Comparative Example 4), there are cases where the target value can be achieved by adjusting the pitch or the pitch ratio. For example, the pitch ratio of Comparative Example 4 is set to a small value, so that the number of bending can be increased to achieve the target value. Therefore, the elastic modulus of the insulator is not limited to 18 MPa or less.

As described above, according to the composite stranded wire conductor 10 of the present embodiment, the primary twist and main twist of the first layer composite stranded wire 11b are performed in a second direction, and the primary twist and main twist of the second layer composite stranded wire 11c are performed in a first direction, so that the directions of the primary twist and main twist for the first layer composite stranded wire 11b are the same, and the directions of the primary twist and main twist for the second layer composite stranded wire 11c are the same. Therefore, the contact by the wires 12 for the primary twists of each layer entering between the wires 12 for the adjacent primary twist is reduced, and the bending resistance can be ensured.

Further, the primary twist of the core bunched strand wire 11a is performed in the first direction, and the primary twist and the main twist of the second layer composite stranded wire 11c are also performed in the first direction, while the primary twist and the main twist of the first layer composite stranded wire 11b are performed in the second direction. Therefore, the metal wires 12 configuring the core bunched strand wire 11a and the metal wires 12 configuring the bunched strand wires of the second layer composite stranded wire 11c do not easily enter between the metal wires 12 of the first layer composite stranded wire 11b. As a result, the shape of the conductor after stranding is unlikely to be flat and the shape stability can be improved.

Particularly, the pitch ratio of the main twist pitch for the second layer composite stranded wire 11c divided by the main twist pitch for the first layer composite stranded wire 11b is 1.00 or more and 2.44 or less, so that the pitch ratio is not less than one and thereby can be manufactured, and the frequency of occurrence of twist float due to the pitch ratio exceeding 2.44 can be suppressed, and the possibility of a decrease in the bending resistance due to the twist float can be reduced.

Therefore, the shape stability can be improved while ensuring the bending resistance.

Further, the diameter of the metal wire 12 is 0.08 mm or less, so that it can contribute to the improvement of the bending resistance by preventing the situation where the diameter of the wire becomes large and the distortion at the time of bending becomes large.

In addition, according to the bending resistant electric wire 1 of the present embodiment, the insulator 20 has an elastic modulus of 18 MPa or less. Here, a decrease in bending resistance due to the insulator 20 around the conductor portion being too hard is prevented. Therefore, the elastic modulus of the insulator is set to 18 MPa or less, so that the bending resistance can be prevented from being extremely reduced.

Although the invention has been described above based on the embodiments, the invention is not limited to the above embodiment, and changes may be made without departing from the spirit of the present invention.

For example, the bending resistant electric wire 1 according to the present embodiment may be formed by a large number of, for example, three bunched strand wires 11 to be the innermost layer.

The bending resistant electric wire 1 according to the present embodiment is not necessarily used for a bent portion, and may be provided for a straight portion or the like.

In addition, in the present embodiment, the number of metal wires 12 forming each of the bunched strand wires 11 is the same, but the invention is not limited thereto, and the number of metal wires 12 forming each of the bunched strand wires 11 may be partially different. For example, a bunched strand wire 11 formed by 256 metal wires 12 and a bunched strand wire 11 formed by 80 metal wires 12 may be used in combination.

Further, in the present embodiment, the composite stranded wire conductor 10 is described as being made of pure copper, but the present invention is not limited thereto, and another kind of metal may be used as the material.

### REFERENCE SIGNS LIST

1 Bending resistant electric wire
10 Composite stranded wire conductor
11 Bunched strand wire
11a Core bunched strand wire
11b First layer composite stranded wire
11c Second layer composite stranded wire
12 Metal wire
20 Insulator

What is claimed is:

1. A composite stranded wire conductor comprising:
a core bunched strand wire in which a plurality of conductive metal wires are primarily twisted;
a first layer composite stranded wire including a plurality of first bunched strand wires, wherein a plurality of conductive metal wires are primarily twisted in each of the plurality of first bunched strand wires, and wherein the plurality of first bunched strand wires are mainly twisted around the core bunched strand wire; and
a second layer composite stranded wire including a plurality of second bunched strand wires, wherein a plurality of conductive metal wires are primarily twisted in each of the plurality of second bunched strand wires, and wherein the plurality of second bunched strand wires are mainly twisted around the first layer composite stranded wire,
wherein the plurality of conductive metal wires are primarily twisted in a first direction in the core bunched strand,
wherein the plurality of conductive metal wires are primarily twisted in a second direction opposite to the first direction in each of the plurality of first bunched strand wires,
wherein the plurality of first bunched strand wires are mainly twisted in the second direction at a first main twist pitch in the first layer composite stranded wire,
wherein the plurality of conductive metal wires are primarily twisted in the first direction in each of the plurality of second bunched strand wires,
wherein the plurality of second bunched strand wires are mainly twisted in the first direction at a second main twist pitch in the second layer composite stranded wire,
wherein a primary twist pitch of the core bunched strand wire, a primary twist pitch of the each of the first bunched strand wires, and a primary twist pitch of the each of the second bunched strand wires are substantially the same with each other, and
wherein a pitch ratio obtained by dividing the second main twist pitch by the first main twist pitch is 1.00 or more and 2.44 or less.

2. The composite stranded wire conductor according to claim 1, wherein a diameter of the conductive metal wires forming the core bunched strand wire, the first bunched strand wires, and the second bunched strand wires is 0.08 mm or less.

3. A bending resistant electric wire comprising:
the composite stranded wire conductor according to claim 1; and
an insulator provided on the composite stranded wire conductor,
wherein an elastic modulus of the insulator is 18 MPa or less.
